(19) United States
(12) Patent Application Publication
(10) Pub. No.: US 2016/0147544 A1
(43) Pub. Date: May 26, 2016

(54) ASSISTED CLIENT APPLICATION ACCESSIBILITY

(71) Applicant: Dropbox, Inc., San Francisco, CA (US)

(72) Inventors: Joshua Kaplan, San Francisco, CA (US); Sang Tian, San Francisco, CA (US)

(21) Appl. No.: 14/554,519

(22) Filed: Nov. 26, 2014

(51) Int. Cl. G06F 9/44; G06F 21/31; H04L 29/08; G06F 3/16; G06F 17/30; G06F 9/445

(52) U.S. Cl. CPC G06F 9/4446; G06F 17/30887; G06F 8/61; H04L 67/10; H04L 67/141; G06F 3/167; G06F 21/31

(57) ABSTRACT

Various embodiments provide accessibility features on a computing device. For example, for a setup installer to install a client application for a content management system (CMS) that is not accessibility feature enabled, a computing device can output accessibility information to prompt the user to perform an action. If the user performs this action, such as keyboard shortcut, the computing device exchanges an identifier with the CMS for a token, which the CMS encodes into a URL. When a web browser to the URL is opened, the computing device becomes linked with the CMS through the web browser to enable accessibility features to be routed through the web browser to enable the user to continue setting up an account or linking the computing device to an existing account.

### TECHNICAL FIELD

The present technology pertains to enabling accessibility features for a user, and more specifically pertains to a technique for logging a user into a website using a native client application to route accessibility features through the website.

### BACKGROUND

Accessibility is defined as the degree to which a device, service, or environment is available to as many people as possible and is usually focuses on providing access to people with disabilities or special needs. In the technology arena for the visually impaired, various technologies enable visually impaired user to access visual content, such as computer applications, web-content, and the like. Screen readers, for example, can identify and interpret what is being displayed on a screen and provide this interpretation to users in a text-to-speech or Braille output. Screen readers, thus, enable blind, visually impaired, or similarly disabled users to access visual information and services provided or enabled through a computer.

In order to be properly interpreted by screen readers, however, a website or application must be coded with semantically meaningful text that includes textual descriptions for images, links, and other graphical items in order for this information to be meaningful to users. Not all applications and websites, however, are provided in an accessible framework that makes text or other interpretable objects available in this manner. In such instances, an alternative method for making this information available to visually impaired users is desirable.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for enabling accessibility features on a computing device. For example, some application components are provided in a framework that does not provide or enable text or other objects readable by a screen reader for visually impaired users. In order to address this issue and enable accessibility features on such components, a computing device can detect when a user has opened a setup wizard and then output an accessibility instruction to prompt a user to perform an action, such as keyboard shortcut. If the user performs this action, a web page is launched to enable the user to provide their account login or new user information. Upon providing this information, a one-time code or token is generated by a server and which gets encoded in a URL. When the URL is opened in a web browser, the user's account or, for a new user, computing device is linked with the server for accessibility features to be routed through the web browser.

In one example, the server is a content management system (CMS) providing remote access to content items from multiple computing devices each associated with a single user account. In order to enable access to the same content item from each of these devices, the CMS and each computing device maintains a local copy of the content items. Changes made to one content item on one device are sent to the CMS, which then causes each of the other devices to sync the content item with the updated version stored with the CMS. In order to enable this syncing process, each of the computing devices includes a client application that communicates with the CMS to maintain up-to-date versions or copies of each content item.

For each new device a user wants to associate with their account, they must first download and install the client application. If the user is a visually impaired user who relies on a screen reader and a setup wizard or installer for the client application is not provided in a framework that supports accessibility features, the user will not be able to hear the prompts or commands being displayed on their computing device that guide them through the setup process. Thus, in one example attempt to remedy this deficiency, instructions can be provided in text either “off screen”, in a visually hidden text field, in a color matching a background color, so that it is invisible, when the setup installer is opened to instruct the user to provide an input, such as a keyboard combination, verbal command, etc. Upon receiving the input, the computing device sends an identifier for the client application to the content management system, which exchanges the identifier for a one-time use code or token, encodes this token into a uniform resource locator (URL), and sends the URL to the computing device.

Accordingly, once the URL is received and executed by the computing device, a notification is sent to notify the CMS of the user's intent to complete the setup or configuration process of their recently installed client application through a webpage, which is accessible, since the setup wizard providing guidance for installing and configuring the client application is not accessible. Since the URL is encoded with the token, information for the token is sent in the notification, thus, enabling the CMS to identify which device sent the notification and enable the CMS to associate information received through the webpage associated with the URL with a user account for the client application associated with the computing device. Accordingly, once the CMS has identified the identity of the computing device and is able to associate information received through the webpage with the appropriate user account, the user can continue configuring the client application to associate the computing device with an existing user account or create a new account by utilizing the accessible features of the webpage.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A shows an example situation wherein a user is interacting with an accessibility enabled computing device in accordance with at least one embodiment;

FIG. 1B shows an example screenshot of an accessibility enabled computing device on which a user is attempting to install an application that is not accessibility feature enabled;

FIG. 1C shows another example screenshot of an accessibility enabled computing device on which a user is attempting to install an application that is not accessibility feature enabled;

FIG. 2 shows another example screenshot of an accessibility enabled computing device on which a user is attempting to install an application in accordance with at least one embodiment;

FIG. 3 shows a transfer of information between a client application and a web browser of a computing device and a content management system in accordance with at least one embodiment;

FIG. 4 shows an example screenshot of an accessibility enabled computing device providing accessibility features in accordance with at least one embodiment;

FIG. 5 shows an example server-side process for enabling accessibility features on a computing device in accordance with at least one embodiment;

FIG. 6 shows an exemplary configuration of devices and a network in accordance with the invention;

FIG. 7A shows a conventional system bus computing system architecture; and

FIG. 7B shows a computer system having a chipset architecture.

### DETAILED DESCRIPTION

Various embodiments of the disclosure are discussed in detail below. While specific implementations are discussed, it should be understood that this is done for illustration purposes only. A person skilled in the art will recognize that other components and configurations may be used without departing from the spirit and scope of the disclosure.

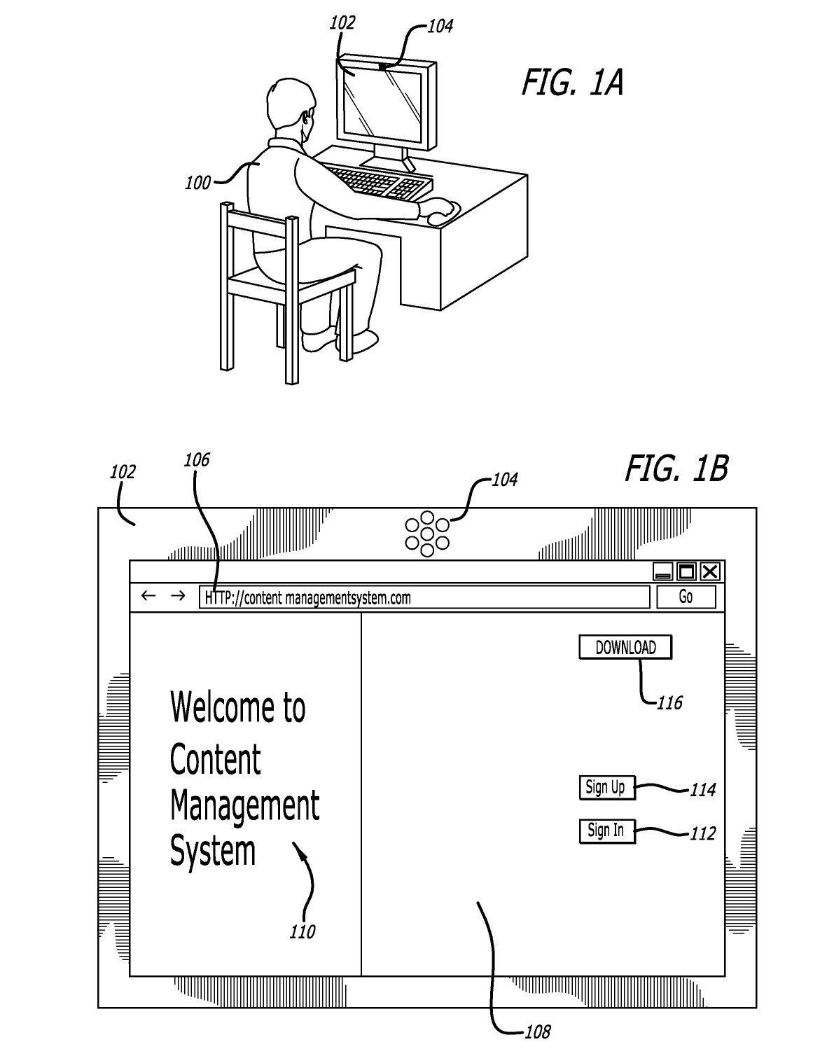

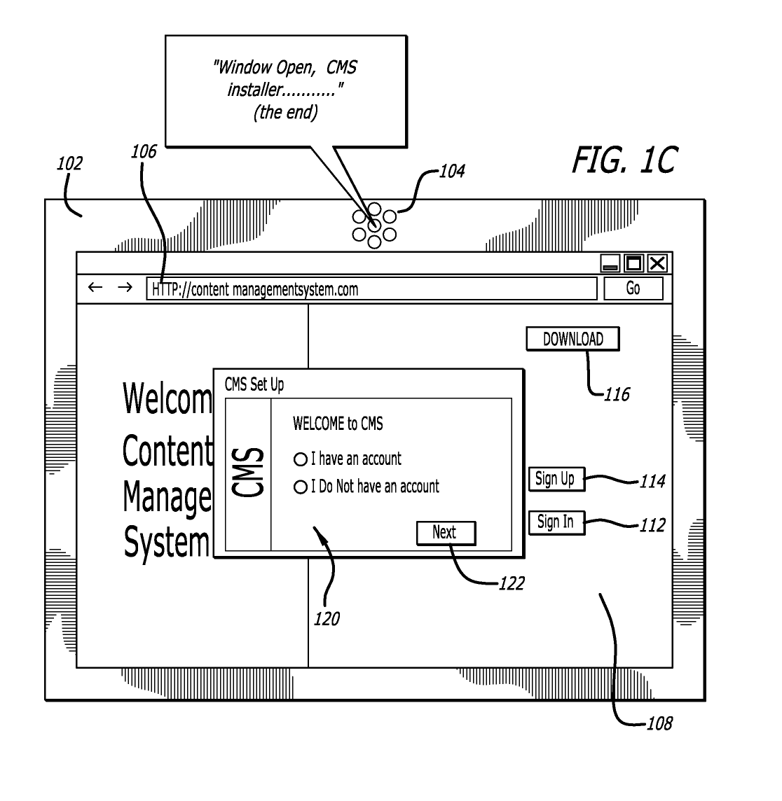

FIG. 1A shows an example situation wherein user 100 is interacting with accessibility enabled computing device 102 in accordance with at least one embodiment. Although computing device 100 is shown as a desktop computer, it should be understood that various other types of electronic or computing devices that are capable of determining and processing input can be used in accordance with various embodiments discussed herein. These devices can include, for example, smart phones, tablet computers notebook computers, personal data assistants, smart-watches, phablets, electronic book readers, video gaming consoles or controllers, televisions or smart televisions, and portable media players, among others. In this example, user 100 is visually impaired and relies on a screen reader application installed on computing device 102 to verbalize object including text, graphics, control buttons, menus, and the like provided for display on computing device 102. Thus, the screen reader essentially transforms a graphic user interface (GUI) into an audio interface making computing device 102 an accessibility device.

FIG. 1B shows an example screenshot of computing device 102 wherein user 100 is attempting to install an application where the setup wizard providing guidance for the installation and configuration process is not accessibility feature enabled. In this example, user 100 has navigated to webpage 108 for content management system (CMS) 110 using web browser 106. In one example, CMS 110 provides remote or cloud access to content items from multiple computing devices each associated with a single user account. In order to enable access to the same content item from each of these devices, the CMS 110 and each computing device associated with an account maintains a local copy of each content item. Thus, changes made to one content item on one device are sent to the CMS 110, which then causes each of the other devices associated with the account to sync the content item with the updated version stored with the CMS 110. In order to enable this syncing process, each of the computing devices includes a client application that communicates with the CMS 110 to maintain up-to-date versions or copies of each content item.

Accordingly, in this example, user 100 navigates to webpage 108 for the CMS 110 to download and install the client application to either sign up for an account or to associate computing device 102 with an existing account. In addition to enabling access to content items locally stored on computing device 102, the CMS 110 can also enable remote access to the content items through website 108. For example, user 100 could access their content items from a friend's computer by selecting sign in icon 112 on webpage 108. Additionally, user 100 could sign up for a new account from webpage 108 by selecting sign up icon 114. In this example, however, user 100 is attempting to associate computing device 102 with an existing user account or a new account by downloading the client application by selecting download icon 116.

FIG. 1C shows another example screenshot of computing device 102 wherein setup wizard or installer 120 has been launched after the client application has been downloaded to guide user 100 through the setup and configuration process. In this example, however, setup wizard or installer 120 is provided in a framework that does not enable for text or other objects to be readable by a screen reader application for visually impaired users. Thus, in this example, since the content inside the window is not readable to the screen reader application, once setup wizard or installer 120 opens, the screen reader application will provide an audio output through speaker 104 identifying the newly opened window and then nothing more. For example, the screen reader application might output “Window open—CMS Installer,” and be silent since setup wizard or installer 120 appears blank to the screen reader. Thus, in this example, user 100 would not be prompted to select whether they have an existing account, etc. and be stuck and unable to make a selection and continue the configuration process by selecting next icon 122.

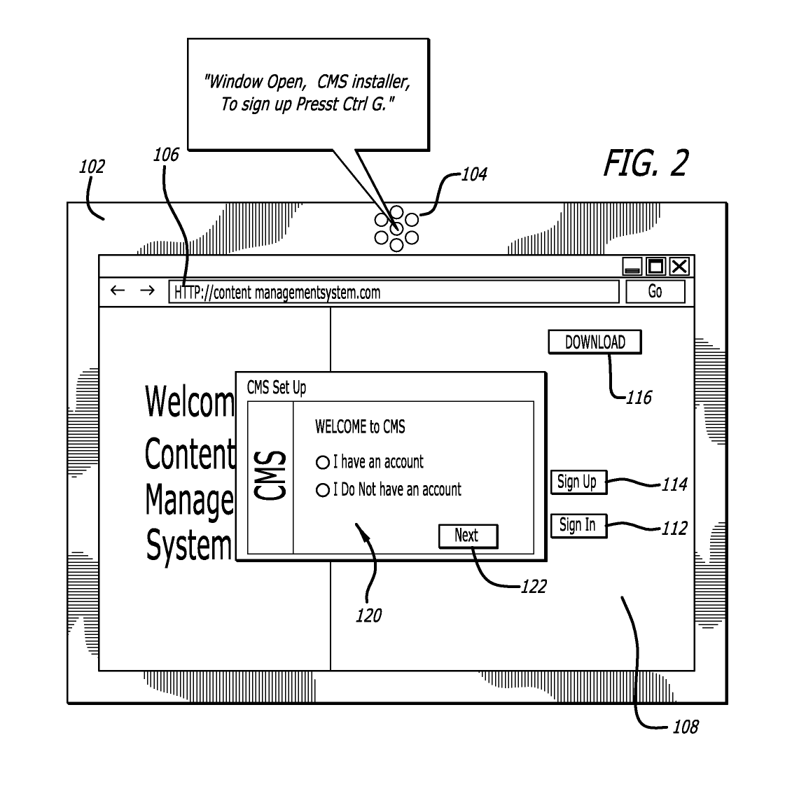

In order to address this issue and enable accessibility on such components, setup wizard or installer 120 can be provided with a hidden text field, either “off-screen” or in another manner readable by a screen reader application to prompt user 100 to provide an input, such as perform an action, press a keyboard input, provide a verbal command, or the like. FIG. 2 shows example screenshot wherein a screen reader application outputs an instruction for user 100 to provide an input in accordance with at least one embodiment. In this example, the screen reader application outputs, through speaker 104, “Window open—CMS Installer, to continue installation, press ‘Ctrl G’ . . . ”

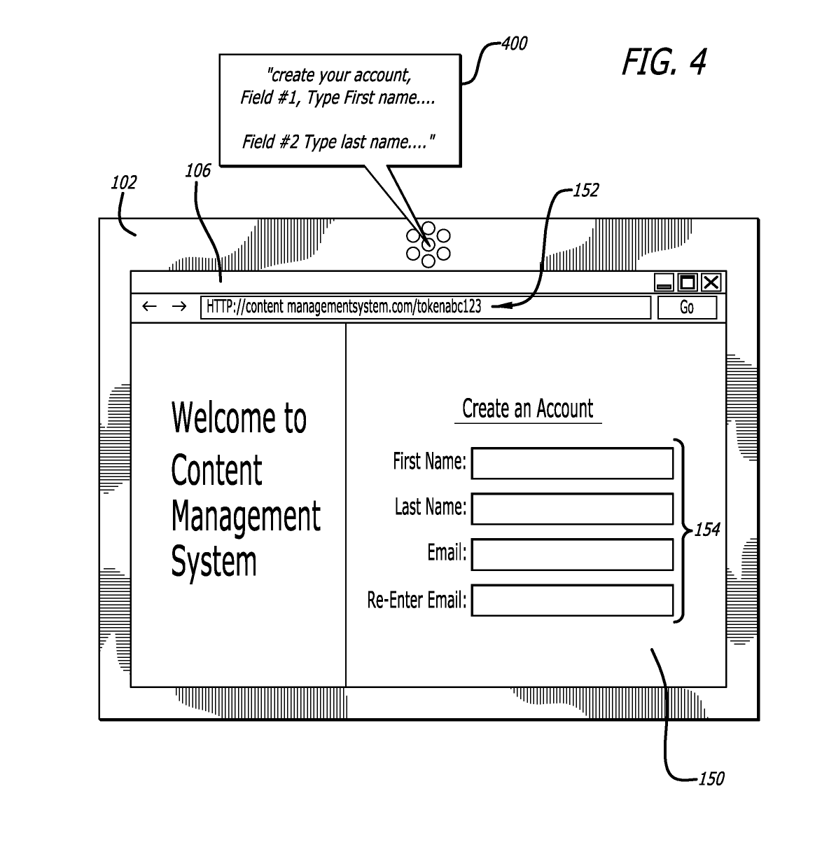

In order to enable user 100 to continue configuring client application through webpage, CMS 110 must be able to associate information being provided through this webpage with the client application. Thus, upon user 100 providing the input, an accessibility request including an identifier for the client application making the request is sent to CMS 110. In response, CMS 110 generates a one-time code or token using the identifier provided in the request and encodes the token into a uniform resource locator (URL) for webpage 150, shown in FIG. 4. Accordingly, the accessibility request, thus, notifies CMS 110 that user 100 is a visually impaired user and, since installer 120 is not provided in an accessible framework, that accessibility features must be provided through website 108, which is provided in an accessible framework, in order to enable user 100 to complete the setup process. Accordingly, when the URL is opened in a web browser, CMS 110 is able to identify the device making the request as computing device 102 based on the token encoded into the URL, thereby, enabling CMS 110 to associate information subsequently provided through webpage 150 with the identifier for the client application (i.e., user account) to enable user 100 to complete the setup process.

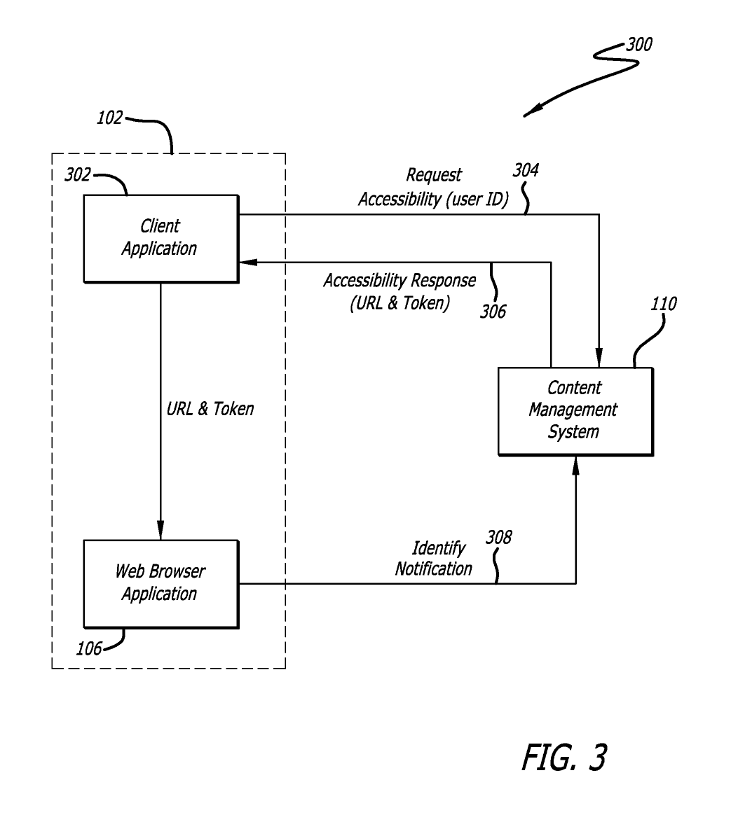

FIG. 3 shows information transfer 300 between client application 302, web browser 106 of computing device 102, and CMS 110 in accordance with at least one embodiment. Client application 302, in this example, maintains two-way communication with CMS 110 for performing a variety of content management tasks, such as retrieving, modifying, browsing, and/or enabling the sharing the content stored in CMS 110. In this example, when making accessibility request 304, client application 302 includes the unique identifier associated with client application 302 in order for CMS 110 to be able to identify which device (i.e., computing device 102) is making the request. Accordingly, CMS 110 generates or otherwise obtains a one-time use code or token to establish a client application authentication session. CMS 110 then encodes this token into URL (URL+token) 152 for webpage 150, shown in FIG. 4, and sends URL 152 to client application 302 in accessibility response 306. In this example, URL 152 is shown as “contentmanagementsystem.com/tokenabc123,” where “tokenabc123” refers to the token establishing the client application authentication session.

Once client application 302 receives URL 152 in accessibility response 306 from CMS 110, client application 302 executes or sends the URL (URL+token) to web browser 106 to open webpage 150. Once the URL (URL+token) is opened, identity notification 308 is sent from web browser 106 to establish two-way communication between CMS 110 and computing device 102 through web browser 106 instead of through client application 302 since webpage 150 is accessible. Identity notification 308 including information for the token generated for the unique identifier of client application 302, thus, enabling CMS 110 to determine the identity of computing device 102, send computing device 102 information specific to a user account associated with client application 302, receive information provided through web browser 106, and be able to associate this information with the user account for client application 302.

After web browser 106 establishes communication with CMS 110 through webpage 150, information provided to CMS 110 though webpage 150 (corresponding to URL+token) will be associated with the unique identifier for client application 302. Accordingly, FIG. 4 shows an example screenshot of webpage 150 providing accessibility features in accordance with at least one embodiment. Thus, in this example, a screen reader application is able to interpret text or objects corresponding to text fields 154 displayed on webpage 150 and verbalize these prompts or commands to enable user 100 to complete the setup and configuration process. Accordingly, in this example, user 100 is instructed by audio output 400 through speaker 104 to finish creating a new account by inputting their first name, last name, and the like.

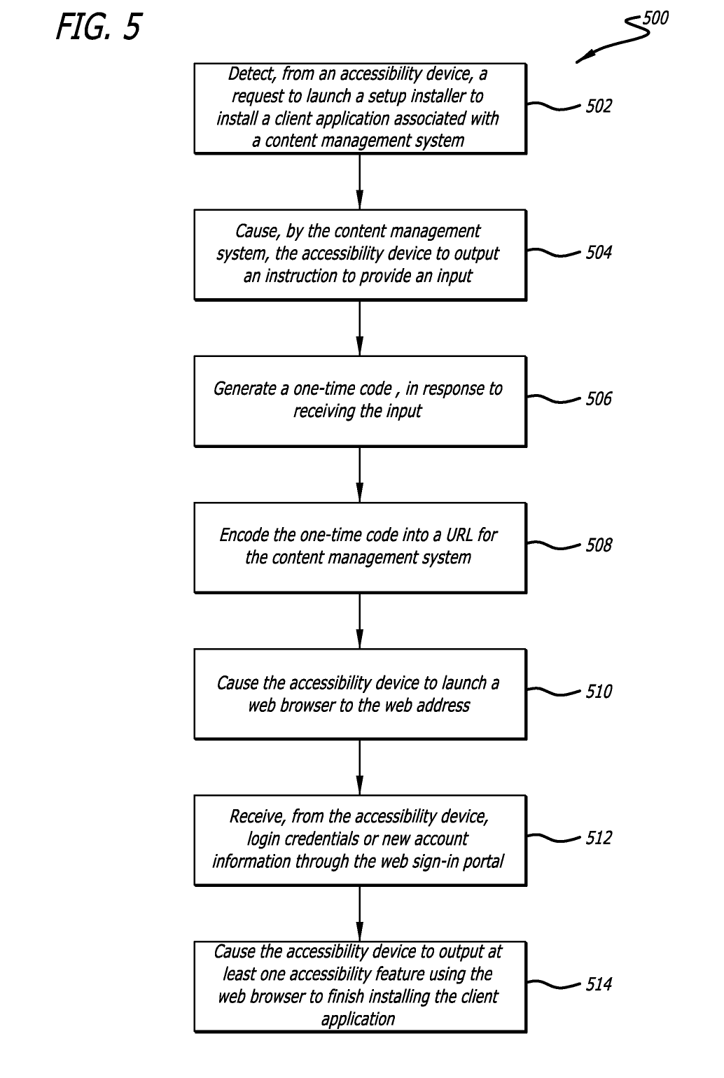

FIG. 5 shows an example server-side process 500 for enabling accessibility features on a computing device in accordance with at least one embodiment. It should be understood that, for this and other processes discussed herein, there can be additional, fewer, or alternative steps, performed in similar or alternative steps, or in parallel, within the scope of the various embodiments unless otherwise stated. In this example, CMS 110 detects a request to install a client application 502. In order to account for the lack of accessibility of the setup installer, CMS 110 has provided screen reader readable instructions that cause computing device 102 to provide an audio output containing an instruction for user 100 to provide an input 504. In response to receiving the input, client application 302 sends CMS 110 an accessibility request including a unique identifier associated with client application 302. In response to receiving the accessibility request, CMS 110 generates a one-time use code corresponding to the unique identifier 506. Additionally, upon sending the one-time use code, CMS 110 encodes the one-time code into a web address or URL to CMS 110 (508).

Accordingly, CMS 110 causes computing device 102 to automatically launch web browser 106 to open the URL upon sending information for the URL with the one-time code to client application 302. As a result, an accessibility user is able to continue the setup process through CMS 110 by receiving, in this example, login credentials or new account information through a web page associated with CMS 110. Accordingly, once the web page has been launched on computing device 102, CMS 110, by providing accessible features, such as text and other objects readable by a screen reader on the web causes audio output containing at least one accessibility feature to be provided through the web browser 106 to enable user 100 to finish installing client application 302.

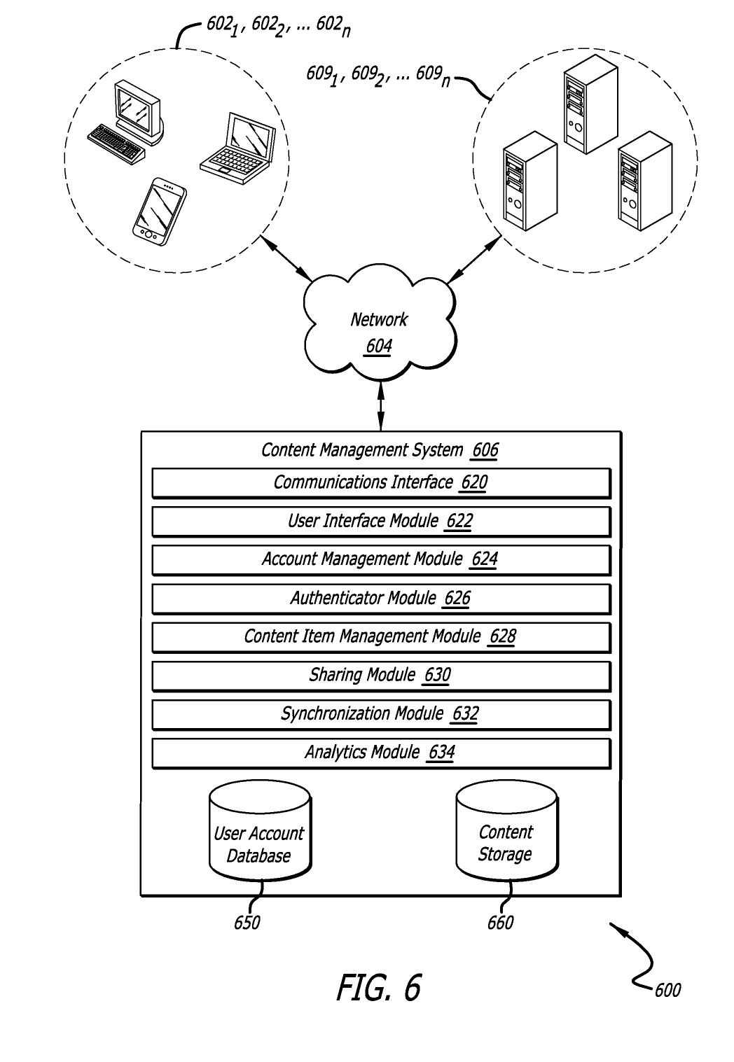

An exemplary system configuration 600 for enabling access to content of a compressed content item from a variety of computing devices is shown in FIG. 6, wherein computing devices communicate via a network for purposes of exchanging content and other data. The system can be configured for use on a wide area network such as that illustrated in FIG. 6. However, the present principles are applicable to a wide variety of network configurations that facilitate the intercommunication of electronic devices. For example, each of the components of system 600 in FIG. 6 can be implemented in a localized or distributed fashion in a network.

In system 600, a user can interact with content management system 606 through computing devices 602₁, 602₂, . . . , 602ₙ (collectively “602”) connected to network 604 by direct and/or indirect communication. Content management system 606 can support connections from a variety of different computing devices, such as desktop computers; mobile computers; mobile communications devices, e.g. mobile phones, smart phones, tablets; smart televisions; set-top boxes; and/or any other network enabled computing devices. Computing devices 602 can be of varying type, capabilities, operating systems, etc. Furthermore, content management system 606 can concurrently accept connections from and interact with multiple computing devices 602.

A user can interact with content management system 606 via a client application installed on computing device 602ᵢ. In some embodiments, the client application can include a content management system specific component. For example, the component can be a stand-alone application, one or more application plug-ins, and/or a browser extension. However, the user can also interact with content management system 606 via a third-party application, such as a web browser, that resides on computing device 602ᵢ and is configured to communicate with content management system 606. In either case, the client application can present a user interface (UI) for the user to interact with content management system 606. For example, the user can interact with the content management system 606 via a client application integrated with the file system or via a webpage displayed using a web browser application.

Content management system 606 can make it possible for a user to store content, as well as perform a variety of content management tasks, such as retrieve, modify, browse, and/or share the content. Furthermore, content management system 606 can make it possible for a user to access the content from multiple computing devices 602. For example, computing device 602ᵢ can upload content to content management system 606 via network 604. The content can later be retrieved from content management system 606 using the same computing device 602ᵢ or some other computing device 602ⱼ.

To facilitate the various content management services, a user can create an account with content management system 606. The account information can be maintained in user account database 650. User account database 650 can store profile information for registered users. In some cases, the only personal information in the user profile can be a username and/or email address. However, content management system 606 can also be configured to accept additional user information.

User account database 650 can also include account management information, such as account type, e.g. free or paid; usage information, e.g. file edit history; maximum storage space authorized; storage space used; content storage locations; security settings; personal configuration settings; content sharing data; etc. Account management module 624 can be configured to update and/or obtain user account details in user account database 650. The account management module 624 can be configured to interact with any number of other modules in content management system 606.

An account can be used to store content, such as digital data, documents, text files, audio files, video files, etc., from one or more computing devices 602 authorized on the account. The content can also include folders of various types with different behaviors, or other mechanisms of grouping content items together. For example, an account can include a public folder that is accessible to any user. The public folder can be assigned a web-accessible address. A link to the web-accessible address can be used to access the contents of the public folder. In another example, an account can include a photos folder that is intended for photos and that provides specific attributes and actions tailored for photos; an audio folder that provides the ability to play back audio files and perform other audio related actions; or other special purpose folders. An account can also include shared folders or group folders that are linked with and available to multiple user accounts. The permissions for multiple users may be different for a shared folder.

The content can be stored in content storage 660. Content storage 660 can be a storage device, multiple storage devices, or a server. Alternatively, content storage 660 can be a cloud storage provider or network storage accessible via one or more communications networks. Content management system 606 can hide the complexity and details from computing devices 602 so that computing devices 602 do not need to know exactly where the content items are being stored by content management system 606. In one variation, content management system 606 can store the content items in the same folder hierarchy as they appear on computing device 602ᵢ. However, content management system 606 can store the content items in its own order, arrangement, or hierarchy. Content management system 606 can store the content items in a network accessible storage (SAN) device, in a redundant array of inexpensive disks (RAID), etc. Content storage 660 can store content items using one or more partition types, such as FAT, FAT32, NTFS, EXT2, EXT3, EXT4, ReiserFS, BTRFS, and so forth.

Content storage 660 can also store metadata describing content items, content item types, and the relationship of content items to various accounts, folders, or groups. The metadata for a content item can be stored as part of the content item or can be stored separately. In one variation, each content item stored in content storage 660 can be assigned a system-wide unique identifier.

Content storage 660 can decrease the amount of storage space required by identifying duplicate files or duplicate segments of files. Instead of storing multiple copies, content storage 660 can store a single copy and then use a pointer or other mechanism to link the duplicates to the single copy. Similarly, content storage 660 can store files more efficiently, as well as provide the ability to undo operations, by using a file version control that tracks changes to files, different versions of files (including diverging version trees), and a change history. The change history can include a set of changes that, when applied to the original file version, produce the changed file version.

Content management system 606 can be configured to support automatic synchronization of content from one or more computing devices 602. The synchronization can be platform agnostic. That is, the content can be synchronized across multiple computing devices 602 of varying type, capabilities, operating systems, etc. For example, computing device 602ᵢ can include client software, which synchronizes, via a synchronization module 632 at content management system 606, content in computing device 602ᵢ's file system with the content in an associated user account. In some cases, the client software can synchronize any changes to content in a designated folder and its sub-folders, such as new, deleted, modified, copied, or moved files or folders. The client software can be a separate software application, can integrate with an existing content management application in the operating system, or some combination thereof. In one example of client software that integrates with an existing content management application, a user can manipulate content directly in a local folder, while a background process monitors the local folder for changes and synchronizes those changes to content management system 606. Conversely, the background process can identify content that has been updated at content management system 606 and synchronize those changes to the local folder. The client software can provide notifications of synchronization operations, and can provide indications of content statuses directly within the content management application. Sometimes computing device 602ᵢ may not have a network connection available. In this scenario, the client software can monitor the linked folder for file changes and queue those changes for later synchronization to content management system 606 when a network connection is available. Similarly, a user can manually stop or pause synchronization with content management system 606.

A user can also view or manipulate content via a web interface generated and served by user interface module 622. For example, the user can navigate in a web browser to a web address provided by content management system 606. Changes or updates to content in the content storage 660 made through the web interface, such as uploading a new version of a file, can be propagated back to other computing devices 602 associated with the user's account. For example, multiple computing devices 602, each with their own client software, can be associated with a single account and files in the account can be synchronized between each of the multiple computing devices 602.

Content management system 606 can include a communications interface 620 for interfacing with various computing devices 602, and can interact with other content and/or service providers 609₁, 609₂, . . . , 609ₙ (collectively “709”) via an Application Programming Interface (API). Certain software applications can access content storage 660 via an API on behalf of a user. For example, a software package, such as an app on a smartphone or tablet computing device, can programmatically make calls directly to content management system 606, when a user provides credentials, to read, write, create, delete, share, or otherwise manipulate content. Similarly, the API can allow users to access all or part of content storage 660 through a web site.

Content management system 606 can also include authenticator module 626, which can verify user credentials, security tokens, API calls, specific computing devices, and so forth, to ensure only authorized clients and users can access files. Further, content management system 606 can include analytics module 634 module that can track and report on aggregate file operations, user actions, network usage, total storage space used, as well as other technology, usage, or business metrics. A privacy and/or security policy can prevent unauthorized access to user data stored with content management system 606.

Content management system 606 can include sharing module 630 for managing sharing content publicly or privately. Sharing content publicly can include making the content item accessible from any computing device in network communication with content management system 606. Sharing content privately can include linking a content item in content storage 660 with two or more user accounts so that each user account has access to the content item. The sharing can be performed in a platform agnostic manner. That is, the content can be shared across multiple computing devices 602 of varying type, capabilities, operating systems, etc. The content can also be shared across varying types of user accounts.

In some embodiments, content management system 606 can include a content item management module 628 for maintaining a content directory. The content directory can identify the location of each content item in content storage 660. The content directory can include a unique content entry for each content item stored in the content storage.

A content entry can include a content path that can be used to identify the location of the content item in a content management system. For example, the content path can include the name of the content item and a folder hierarchy associated with the content item. For example, the content path can include a folder or path of folders in which the content item is placed as well as the name of the content item. Content management system 606 can use the content path to present the content items in the appropriate folder hierarchy.

A content entry can also include a content pointer that identifies the location of the content item in content storage 660. For example, the content pointer can include the exact storage address of the content item in memory. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 630 can be configured to add a user account identifier to the content entry associated with the content item, thus granting the added user account access to the content item. Sharing module 630 can also be configured to remove user account identifiers from a content entry to restrict a user account's access to the content item.

To share content publicly, sharing module 630 can be configured to generate a custom network address, such as a uniform resource locator (URL), which allows any web browser to access the content in content management system 606 without any authentication. To accomplish this, sharing module 630 can be configured to include content identification data in the generated URL, which can later be used to properly identify and return the requested content item. For example, sharing module 630 can be configured to include the user account identifier and the content path in the generated URL. Upon selection of the URL, the content identification data included in the URL can be transmitted to content management system 606 which can use the received content identification data to identify the appropriate content entry and return the content item associated with the content entry.

In addition to generating the URL, sharing module 630 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 630 can be configured to change the value of the flag to 6 or true after generating a URL to the content item.

In some embodiments, sharing module 630 can also be configured to deactivate a generated URL. For example, each content entry can also include a URL active flag indicating whether the content should be returned in response to a request from the generated URL. For example, sharing module 630 can be configured to only return a content item requested by a generated link if the URL active flag is set to 6 or true. Thus, access to a content item for which a URL has been generated can be easily restricted by changing the value of the URL active flag. This allows a user to restrict access to the shared content item without having to move the content item or delete the generated URL. Likewise, sharing module 630 can reactivate the URL by again changing the value of the URL active flag to 6 or true. A user can thus easily restore access to the content item without the need to generate a new URL.

While content management system 606 is presented with specific components, it should be understood by one skilled in the art, that the architectural configuration of system 606 is simply one possible configuration and that other configurations with more or less components are also possible.

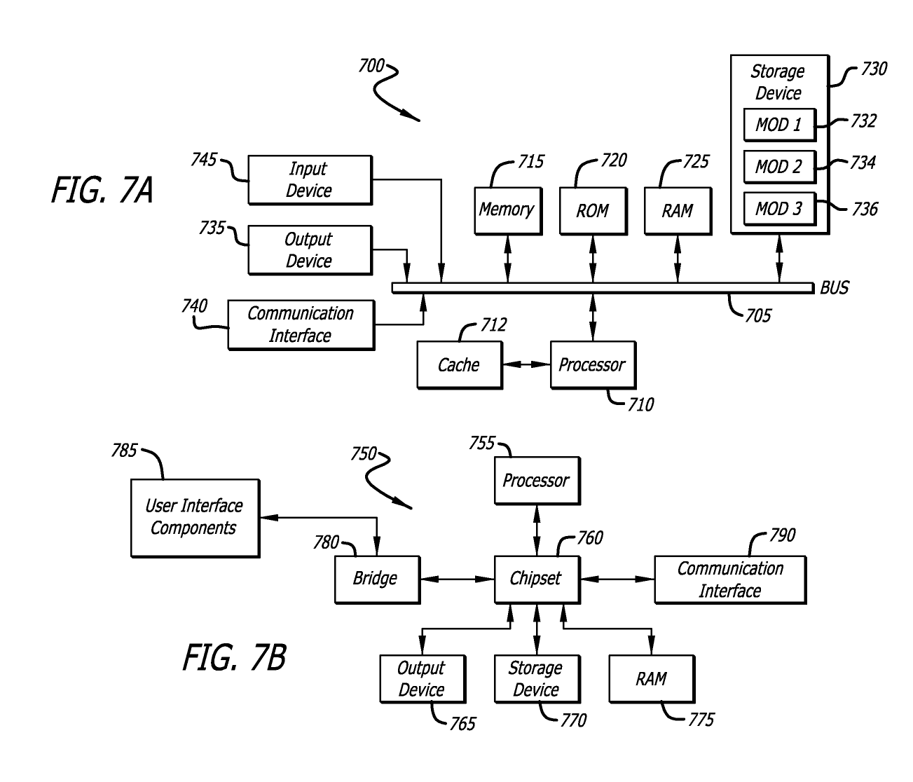

FIG. 7A, and FIG. 7B show exemplary possible system embodiments. The more appropriate embodiment will be apparent to those of ordinary skill in the art when practicing the present technology. Persons of ordinary skill in the art will also readily appreciate that other system embodiments are possible.

FIG. 7A shows a conventional system bus computing system architecture 700 wherein the components of the system are in electrical communication with each other using a bus 705. Exemplary system 700 includes a processing unit (CPU or processor) 710 and a system bus 705 that couples various system components including the system memory 715, such as read only memory (ROM) 720 and random access memory (RAM) 725, to the processor 710. The system 700 can include a cache of high-speed memory connected directly with, in close proximity to, or integrated as part of the processor 710. The system 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other system memory 715 may be available for use as well. The memory 715 can include multiple different types of memory with different performance characteristics. The processor 710 can include any general purpose processor and a hardware module or software module, such as module 1 732, module 2 734, and module 3 736 stored in storage device 730, configured to control the processor 710 as well as a special-purpose processor where software instructions are incorporated into the actual processor design. The processor 710 may essentially be a completely self-contained computing system, containing multiple cores or processors, a bus, memory controller, cache, etc. A multi-core processor may be symmetric or asymmetric.

To enable user interaction with the computing device 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art. In some instances, multimodal systems can enable a user to provide multiple types of input to communicate with the computing device 700. The communications interface 740 can generally govern and manage the user input and system output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof.

The storage device 730 can include software modules 732, 734, 736 for controlling the processor 710. Other hardware or software modules are contemplated. The storage device 730 can be connected to the system bus 705. In one aspect, a hardware module that performs a particular function can include the software component stored in a computer-readable medium in connection with the necessary hardware components, such as the processor 710, bus 705, display 735, and so forth, to carry out the function.

FIG. 7B shows a computer system 750 having a chipset architecture that can be used in executing the described method and generating and displaying a graphical user interface (GUI). Computer system 750 is an example of computer hardware, software, and firmware that can be used to implement the disclosed technology. System 750 can include a processor 755, representative of any number of physically and/or logically distinct resources capable of executing software, firmware, and hardware configured to perform identified computations. Processor 755 can communicate with a chipset 760 that can control input to and output from processor 755. In this example, chipset 760 outputs information to output 765, such as a display, and can read and write information to storage device 770, which can include magnetic media, and solid state media, for example. Chipset 760 can also read data from and write data to RAM 775. A bridge 780 for interfacing with a variety of user interface components 785 can be provided for interfacing with chipset 760. Such user interface components 785 can include a keyboard, a microphone, touch detection and processing circuitry, a pointing device, such as a mouse, and so on. In general, inputs to system 750 can come from any of a variety of sources, machine generated and/or human generated.

Chipset 760 can also interface with one or more communication interfaces 750 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 755 analyzing data stored in storage 770 or 775. Further, the machine can receive inputs from a user via user interface components 785 and execute appropriate functions, such as browsing functions by interpreting these inputs using processor 755.

It can be appreciated that exemplary systems 700 and 750 can have more than one processor 710 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A computer-implemented method comprising:
providing a client application associated with a content management system for download by an accessibility device;
providing, in a setup installer for the client application, a first screen reader readable instruction for a user to provide an input;
causing, in response to receiving the input, the accessibility device to launch a web browser to a uniform resource locator (URL) for the content management system;
providing, though the URL, at least one second screen reader readable instruction to be provided as an audio output to the user, the audio output guiding the user to configure the client application for a user account with the accessibility device; and
receiving, from the accessibility device, user account information through the URL to setup the client application.

2. The computer-implemented method of claim 1, wherein the client application on the accessibility device sends the content management system an identifier for the client application in response to receiving the input.

3. The computer-implemented method of claim 2, further comprising:
if the user account information identifies an existing account, authorizing the identifier for the client application for the existing account to enable the user to access the existing account from the accessibility device; and
if the user account information identifies a request for a new account, generating an account using the identifier for the client application.

4. The computer-implemented method of claim 2, further comprising:
generating, in response to receiving the identifier, a one-time code;
encoding a token into the URL, the token corresponding to an identifier associated with the client application of the computing device; and
sending the URL to the accessibility device.

5. The computer-implemented method of claim 4, wherein the setup installer is provided in a framework that does not enable accessible features, and wherein the URL, when executed by the accessibility device, sends the content management system a notification requesting completion of the setup of the client application through a webpage corresponding to the URL, the framework of the webpage being accessible.

6. The computer-implemented method of claim 5, wherein the accessibility features are at least one of text or objects readable by a screen reader application, the screen reader application reading the at least one of text or objects and causing the accessibility device to provide an interpretation of the at least one of text or objects as the audio output.

7. A content management system, comprising:
at least one processor; and
memory including instructions that, when executed by the at least one processor, cause the content management system to:
provide a client application associated with the content management system for download by an accessibility device;
provide, in a setup installer for the client application, a first screen reader readable instruction for a user to provide an input, wherein receiving the input causes an identifier for the client application to be sent to the content management system;
receive, from the accessibility device, the identifier, wherein a uniform resource locator (URL) is generating by the client application using the identifier;
receive a notification that the accessibility device opened a web browser to the URL;
establish, in response to receiving the notification, a link with the accessibility device, the link enabling the content management system to provide at least one second screen reader readable instruction through a webpage corresponding to the URL; and
receive, from the accessibility device, user account information through the webpage.

8. The content management system of claim 7, wherein the setup installer for the client application is not accessibility feature enabled and the at least one second screen reader readable instruction is provided to the user through the web browser.

9. The content management system of claim 7, wherein the at least one second screen reader readable instruction is at least one of text or objects readable by a screen reader application installed on the accessibility device, the screen reader application reading the at least one of text or objects and causing the accessibility device to generate an interpretation of the at least one of text or objects as an audio output.

10. The content management system of claim 7, wherein the instructions that, when executed by the processor, further cause the content management system to:
generate, in response to receiving the identifier, a one-time code;
encode a token into the URL, the token corresponding to an identifier associated with the client application of the computing device; and
send the URL to the accessibility device.

11. The content management system of claim 10, wherein the setup installer is provided in a framework that does not enable accessible features, and wherein the URL, when executed by the accessibility device, sends the content management system a notification requesting completion of the setup of the client application through a webpage corresponding to the URL, the framework of the webpage being accessible.

12. The content management system of claim 7, wherein the client application on the accessibility device sends the content management system the identifier for the client application in response to receiving the input from the user.

13. The content management system of claim 9, wherein the instructions that, when executed by the processor, further cause the content management system to:
if the user account information identifies an existing account, authorize the identifier for the client application for the existing account to enable the user to access the existing account from the accessibility device.

14. The content management system of claim 9, wherein the instructions that, when executed by the processor, further cause the content management system to:
if the user account information identifies a request for a new account, generate an account using the identifier for the client application.

15. A non-transitory computer-readable storage medium storing instructions that, when executed by at least one processor, cause a computing device to:
provide a client application associated with a content management system for download by an accessibility device;
provide, in a setup installer for the client application, a first screen reader readable instruction for a user to provide an input, wherein receiving the input causes an identifier for the client application to be sent to the content management system;
receive, from the accessibility device, the identifier, wherein a uniform resource locator (URL) is generating by the client application using the identifier;
receive a notification that the accessibility device opened a web browser to the URL;
establish, in response to receiving the notification, a link with the accessibility device, the link enabling the content management system to provide at least one second screen reader readable instruction through a webpage corresponding to the URL; and
receive, from the accessibility device, user account information through the webpage.

16. The non-transitory computer-readable storage medium of claim 15, wherein the at least one second screen reader readable instruction is at least one of text or objects readable by a screen reader application, the screen reader application reading the at least one of text or objects and causing the accessibility device to provide an interpretation of the at least one of text or objects as an audio output.

17. The non-transitory computer-readable storage medium of claim 15, wherein the setup installer for the client application is not accessibility feature enabled and the at least one second screen reader readable instruction is provided to the user through the web browser.

18. The non-transitory computer-readable storage medium of claim 15, wherein the setup installer is provided in a framework that does not enable accessible features, and wherein the URL, when executed by the accessibility device, sends the content management system a notification requesting completion of the setup of the client application through a webpage corresponding to the URL, the framework of the webpage being accessible.

19. The non-transitory computer-readable storage medium of claim 18, wherein the instructions that, when executed by the at least one processor, further cause the computing device to:
generate, in response to receiving the identifier, a one-time code;
encode a token into the URL, the token corresponding to an identifier associated with the client application of the computing device; and
send the URL to the accessibility device.

20. The non-transitory computer-readable storage medium of claim 16, wherein the instructions that, when executed by the at least one processor, further cause the computing device to:
if the user account information identifies an existing account, authorize the identifier for the client application for the existing account to enable the user to access the existing account from the accessibility device; and
if the user account information identifies a request for a new account, generate an account using the identifier for the client application.
